(19) United States
(12) Patent Application Publication
(10) Pub. No.: US 2019/0237986 A1
(43) Pub. Date: Aug. 1, 2019

(54) Wireless Charger System

(71) Applicant: Bikashagarwal, Inc., Michigan City, IN (US)

(72) Inventor: Sajag Agarwal, Chicago, IL (US)

(21) Appl. No.: 16/261,555

(22) Filed: Jan. 29, 2019

Related U.S. Application Data
(60) Provisional application No. 62/623,423, filed on Jan. 29, 2018.

(51) Int. Cl. H02J 7/02; H02J 7/00

(52) U.S. Cl. CPC H02J 7/025; H02J 7/0045

(57) ABSTRACT

A wireless charger module comprising an inductive transmission pad and at least one attachment mechanism. A receiving mechanism connects the inductive transmission pad to a surface. The attachment mechanism is removably received by the receiving mechanism resulting in mounting of the wireless charger pad on the surface. The attachment mechanism allows for removal of the receiving mechanism. The system has interchangeable parts.

### PRIORITY CLAIM

This U.S. non-provisional application claims the benefit of U.S. provisional application No. 62/623,423, filed on Jan. 29, 2018, and titled Wireless Charger System, the entire contents of which are incorporated herein by reference.

### FIELD OF THE DISCLOSURE

The present disclosure relates to apparatuses and methods for wireless charging of electronic devices. More specifically, this disclosure is directed to a device for deploying a wireless charger pad, replacement of the same, and a method of installing removable wireless charger pads.

### BACKGROUND

Electronic devices frequently include a wireless receiver to supply current to the device charging circuit, generally by using inductance or other similar phenomenon. Each wireless power receiver operates with a particular type of wireless charging pad. As the variety of devices increases, so does the need to match a charging pad. Phones on the market at a particular time may be compatible with more than one standard, but the compatibility decreases with the passage of time and the introduction of new wireless charging standards.

Presently, most electronic devices have their own charging system specific to the make or model of the electronic device. This requires specific charging connectors or ports. More electronic devices have wireless charging capability. However, not all devices are compatible with the same wireless charging system. Each electronic device manufacturer wants to create brand loyalty, thus requiring consumers to purchase its own compatible accessories.

This can be frustrating for those with an on-the-go lifestyle and who use electronic devices for business, social, or creative applications. Most electronic devices do not have interchangeable batteries. Therefore, a person would need to find an electrical outlet and plug in or carry a bulky portable battery charger pack in order to stay connected.

What is needed is a charging system with interchangeable capabilities that can support multiple different electronic devices at once.

### SUMMARY

The wireless charging system has a removable pad and can be integrated in a variety of settings and with interchangeable parts. The removable pad and cradle with interchangeable parts can accommodate a variety of electronic devices now and in the future with advances in electronic device design, battery composition, circuitry, and connectivity. The wireless charger system comprises an inductive transmission plate, at least one attachment mechanism mounted to the transmission plate, and at least one receiving mechanism permanently connected to a surface. The attachment mechanism is removably received by the receiving mechanism resulting in mounting of the transmission plate on the surface. The attachment mechanism allows for removal of the receiving mechanism.

### BRIEF DESCRIPTION OF THE DRAWINGS

The invention together with the above and other objects and advantages will be best understood from the following detailed description of the preferred embodiment of the invention shown in the accompanying drawings, wherein:

FIGS. 1A-C depict an overview of one embodiment of the invention;

FIGS. 2A-D depict additional views of one embodiment of the invention;

FIGS. 3A-D depict further views of one embodiment of the invention;

FIGS. 4A-C depict several views of the charging pad component of one embodiment of the invention;

FIG. 5 depicts an overview of another embodiment of the invention;

FIG. 6 depicts an additional overview of another embodiment of the invention;

FIG. 7A-F depict several views of embodiments of the invention;

FIGS. 8A and 8B depict expanded of another embodiment of the invention;

FIGS. 9A and 9B depict side views of another embodiment of the invention;

FIGS. 9C and 9D depict additional views of another embodiment of the invention;

FIGS. 10A and 10B depict views of a further embodiment of the invention; and

FIGS. 11A-C depict additional views of an embodiment of the invention.

### REFERENCE NUMERALS OF THE DRAWINGS

10—device
12—frame
14—charger pad
16—opening
22—lock flange
24—push flange
26—adjacent vertical side
27—vertical side
28—bottom side
30—button
32—groove
34—sidewall projection
36—locking flange receiving notch
38—seal
42—channel
44—bottom
46—locking flange receiving notch
48—bottom surface
50—exemplary embodiment
52—main body
54—charging pad
56—actuator button
58—main body holes
62—main body
64—charger pad
66—first actuator button
68—second actuator button
70—mounting plate
72—aperture
74—seal
80—mounting plate
82—aperture
86—push button
88—push button
90—mounting plate
92—main body
94—aperture
96—button
98—button
102—main body
104—charging pad
106—mounting plate
108—seal
110—secure lockable embodiment
112—main body
114—charging pad
116—button
118—lock
120—aperture
122—mounting plate
126—button

### DETAILED DESCRIPTION

The foregoing summary, as well as the following detailed description of certain embodiments of the present disclosure, will be better understood when read in conjunction with the appended drawings.

As used herein, an element step recited in the singular and preceded with the word “a” or “an” should be understood as not excluding plural said elements or steps, unless such exclusion is explicitly stated. Furthermore, the references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As described herein, embodiments of the system comprise chargers for end users. However, similar ideas may be used to design interchangeable power supplies and charging standards for devices other than consumer electronics.

### Overview

The wireless charging system, despite its name, can provide charging capabilities both wirelessly and with a wired connection to a power source. Interchangeable modules are integrated in with the main body of the system. Some interchangeable modules may be charging pads, USB connectors, lightning cables, laptop charger cables, and standard electrical outlets.

The wireless charging system may be installed in a variety of environments such as dining tables, office desks, conference tables, under seats, in vehicle front or center consoles, in public transportation, at parks, and at events. The wireless charging system may be placed on top or be attached to a surface or may be built in.

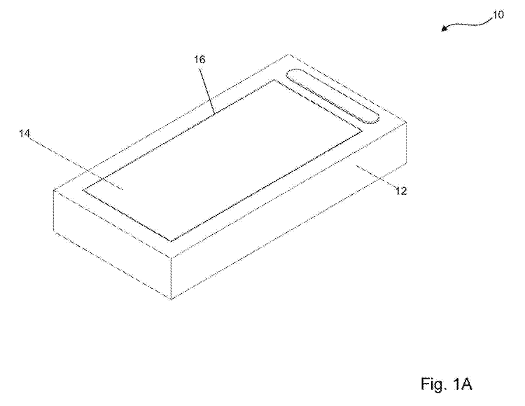

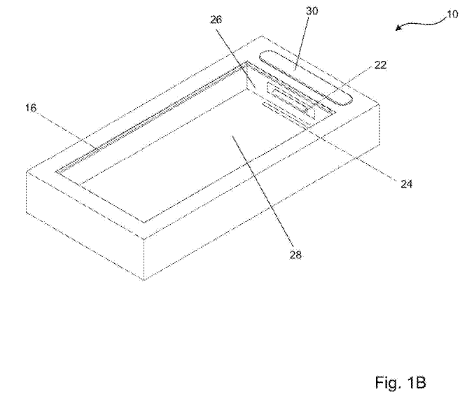

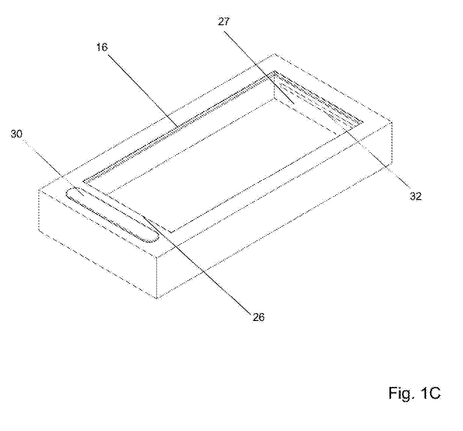

An overview of a device 10 is shown in FIG. 1A. The device 10 comprises a frame 12 and a charger pad 14. As described in subsequent figures, the charger pad 14 is removable from the frame 12. The charger pad 14 is received by an opening 16 defined in the frame 12.

While in FIG. 1A, the frame 12 and charger pad 14 are shown as substantially rectangular, in other embodiments, not shown, the frame and charger pad feature different shapes. In one embodiment, the frame 12 and charger pad 14 have an oval shape. In other embodiment, the frame 12 and charger pad 14 have a substantially circular shape. The key requirement is that the charger pad 14 not use a shape which cannot be tilted into position, as will be described in subsequent figures. As such, certain shapes, such as irregular shapes with many protrusions, will not be compatible. In other embodiments, not shown, a frame is not included around the charger pad. Instead, of a full frame, the device uses a support substrate which is placed on a surface which is installed into an armrest of a vehicle or other structural element.

As the charger pad 14 includes at least one inductive coil, the charger pad 14 shape must be sufficiently large to securely house the coil. The charger pad 14 may be interchangeable. The charger pad 14 may be used in conjunction with other charging modules such as outlets and cables.

While in FIG. 1A, the frame 12 is shown as having similar dimensions and shape as the charger pad 14, different shapes of the frame 12 are envisioned. In one embodiment, the frame 12 consists of a car center console or an armrest. In this embodiment, the frame 12 is much larger than the charger pad 14. The frame 12 however, should have an aperture which matches the profile of the charger pad 14.

The interior of the frame opening 16 is shown in FIG. 1B. The interior surfaces of opening 16 include an extensible lock flange 22 in a button 30 adjacent vertical side 26 of the opening 16 and a bottom push flange 24 in the bottom side 28 of the opening 16. As will be explained in detail below, actuation of the button 30 extends or retracts the bottom push flange 24 and the lock flange 22.

Another view of the opening 16 is shown in FIG. 1C. In this view, the vertical side 27 that opposite of the button 30 adjacent vertical side 26 is visible. The vertical side 27 features a groove 32 near to the edge of the opening 16. In one embodiment, the distance from the edge of the opening 16 is approximately the same as the width of the groove 32.

As will be discussed in detail, the charger pad 14 engages with the groove 32 and the lock flange 22. When the lock flange 22 is disengaged, the push flange 24 lifts the charger pad 14 from the opening allowing the end user to retrieve the charger pad 14

### Installation of Charger Pad

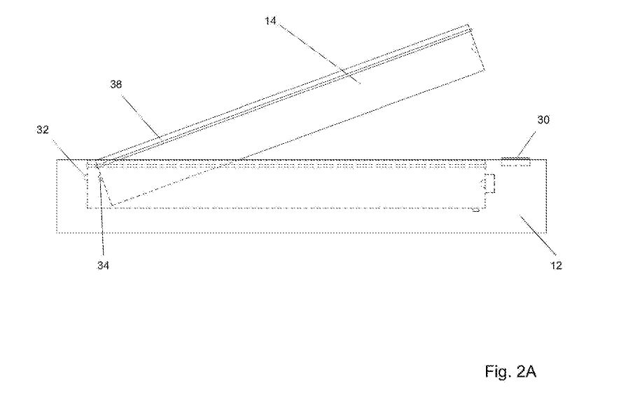

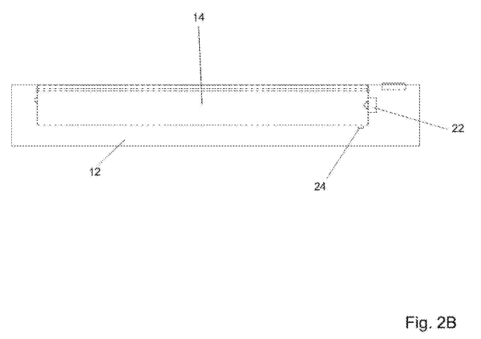

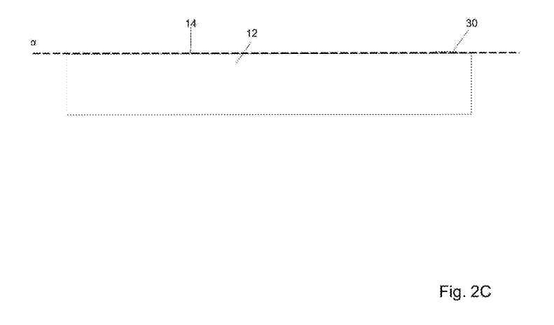

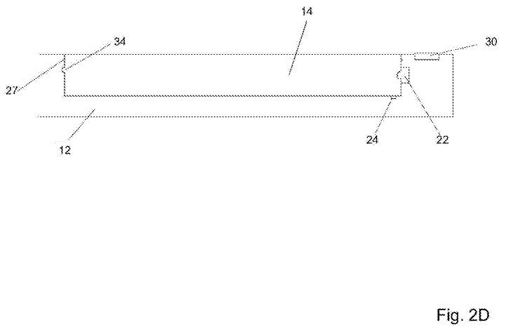

FIGS. 2A-D depict the details of installing the charger pad 14 into the frame 12.

Turning to FIG. 2A, depicted therein is the frame 12 receiving the charger pad 14 while the charger pad is tilted into the opening of the frame 12.

The charger pad 14 includes a perimeter seal 38. The perimeter seal 38 ensures that neither dust nor water enter into the frame 12. The perimeter seal 38 is formed from a rubber gasket, in one embodiment, but can be formed from any form of deformable material, such as a gel encapsulated by a membrane, and the like. As is described below, the seal is supplemental to the function of the embodiment and not necessary in all applications.

As further shown in FIG. 2A, the charger pad 14 also includes a sidewall projection 34 which is received by the notch 32. This sidewall projection 34 aligns the charger pad 14 as it is removably received by the frame 12. The sidewall projection 34 also contains electric prongs or other conductors to convey electricity from the frame 12 to the charge pad 14, in one embodiment.

Depicted in FIG. 2B is the charger 14 seated within the frame 12. The lock flange 22 is engaged into the charger 14. The bottom push flange 24 is flush with the bottom of the charger 14.

Another side view of the frame 12 and charger pad 14 is shown in FIG. 2C. As can be appreciated from FIG. 2C, the charger 14 forms a substantially flat profile along a line of the top of the frame 12. The only component that protrudes from the top of the surface of the frame 12 is the push button 30. In this configuration, the charger pad 14 and frame 12 form a unitary unit due to the precise alignment of the charger pad 14. In one embodiment, the push button 30 is also flush with the surface.

A cross-sectional view of the frame 12 and charger 14 combination is shown in FIG. 2D. The charger 14 sidewall projection 34 is received by a notch in side vertical wall 27. While the charger 14 is installed in the frame 12, the bottom push flange 24 remains retracted, while the locking flange 22 is extended. The push button 30 activates the two active components of the system—the locking flange 22 and the bottom push flange 24.

In operation, once the button 30 is pressed, the locking flange 22 retracts while the bottom push flange 24 raises up which pushes the charger 14 out of the frame 12, presenting the charger pad 14 to the user, allowing the user to remove the charger pad 14 out of the frame 12. To reinstall the charger pad 14 the end user must first align the projection 34 into the notch in the wall 27. The opposite end of the charger pad 14 will snap into place by engaging the locking flange 22. During installation, the button 30 is not pressed, and so the locking flange 22 is extended, but the bottom flange 24 is flush with the frame 12. Once the charger pad 14 is installed, the gasket or seal 38 shown in FIG. 2A engages with the frame 12 ensuring a watertight and dustproof seal.

### Charger and Frame Combinations

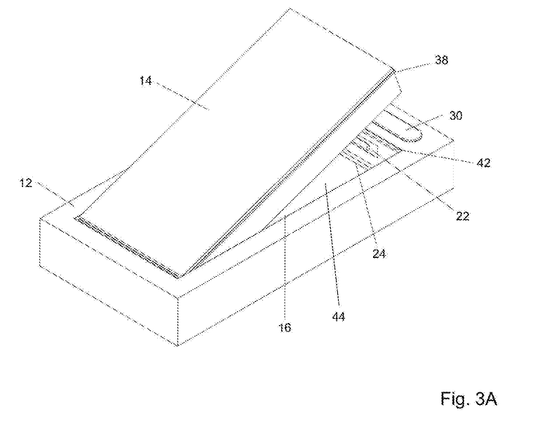

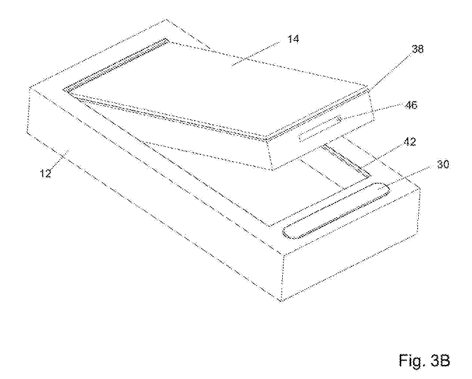

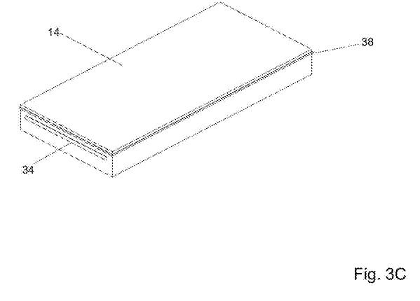

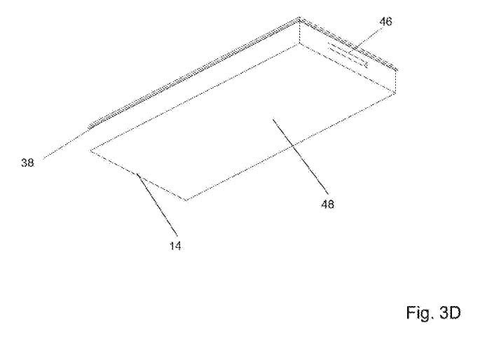

An isometric view showing the charger pad 14 within the frame 12 is shown in FIG. 3A. As visible in FIG. 3A, the charger pad 14 is received by the frame 12 opening 16 and locking flange 22. The bottom push flange 24 is flush with the bottom 44 of the opening 16. The sidewalls of the opening include a channel 42 which receives the gasket or seal 38. The locking flange 22 and the bottom push flange 24 are activated by the push button 30 as described above.

FIG. 3B shows another view of the charger pad 14 being received by the frame 12. In this view, the locking flange receiving notch 46 is most clearly visible.

FIG. 3C in turn shows the charger pad 14 apart from any frame. Visible in FIG. 3C are the gasket or seal 38 and the sidewall projection 34.

FIG. 3D also depicts the charger pad 14, however with the bottom surface 48 visible. As depicted in FIG. 3D, the bottom surface 48 is substantially flat allowing the charger pad 14 to fit into a frame having a substantially flat bottom forming a flat profile resulting in a well-aligned combination as shown in FIG. 2C. FIG. 3D also provides another view of the locking flange receiving notch 46. Compared with the sidewall projection 34 visible on FIG. 3C on the opposite end of the charger pad 14 the locking flange receiving notch 46 is shorter. This is because the locking flange (visible in FIG. 3A, for example) is of a similar length. The length of the locking flange receiving notch 46 was selected to allow for secure locking without requiring a lot of force to facilitate removal of the charging pad 14. If excessive force was required, the charging pad 14 could uncontrollably pop out of the frame. The sidewall projection 34 is longer, and nearly the width of the charging pad 14 to assist in the alignment of the charging pad 14 with a frame.

While the locking flange receiving notch 46 is shown as a single notch in FIG. 3D, in other embodiments, the mechanism uses notches (not shown). Similarly, while in FIG. 3C, the sidewall projection 34 is shown as a single element, in other embodiments, the sidewall projection 34 comprises multiple projections.

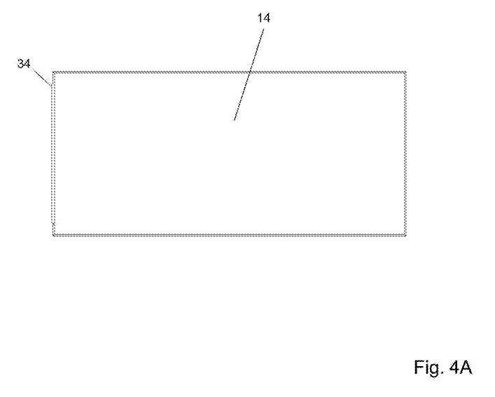

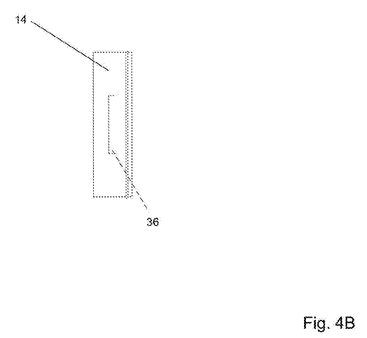

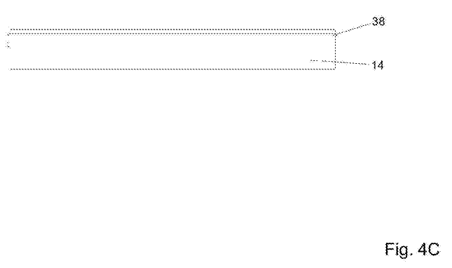

FIG. 4A depicts a top view of the charger pad 14, showing the sidewall projection 34 used in alignment of the charger pad 14. FIG. 4B depicts a side view of the charger pad 14 showing the locking flange receiving notch 36. Finally FIG. 4C depicts a different side view of the charger pad 14 showing the flange or seal 38.

### Vertical Mounting and Locking

While in the depicted embodiments, the pad and the frame are shown in a substantially horizontal configuration, the system can be used in a vertical stand as well. In this embodiment, the frame encompasses the front of the charger pad and provides a surface against which a charging device abuts against. The distance from the front of the frame to the charger pad is sufficiently large as to allow the charging pad to be removed from the frame, when the button is pressed. Some version of this vertical embodiment incorporate a case that attaches to the bottom of the base. Further, the embodiment would use a spring loaded feature and a hinge to hold the components against the plate.

As will be described below in conjunction with the alternative tabletop or round embodiment, some embodiments include a locking feature. While not shown in the figures, the frame of the rectangular embodiment can also include a lock that prevents the button from releasing the charging pad. In one such embodiment, the keyhole is placed next to the button. Such embodiments are suitable for locations open to the public, such as a coffee shop or a publicly accessible aircraft.

### Waterproof and Dustproof Line

As described above, in some embodiments the charger pad 14 and the frame 12 include features that allow for the combination to result in removable waterproof and dustproof mating of the two components. In some applications such a connection is very important as it prevents damage to any other components in communication with the frame 12, such as other car components.

In other embodiments, not shown, the charger pad 14 does not include waterproof and dustproof features. For example, while in FIG. 2A, the charger pad 14 is shown as having a perimeter seal 38, in another embodiment, the perimeter seal 38 is omitted. In such embodiments, the charger pad 14 is expected to be routinely removed by the user and cleaned. In some embodiments, the frame 12 also includes a vent or drain to allow any fluid accumulated within the opening to escape or evaporate.

### Tabletop Embodiment

While the embodiment shown in FIGS. 1-4C was substantially rectangular and designed to result in a substantially flush surface, other embodiments shown in subsequent figures.

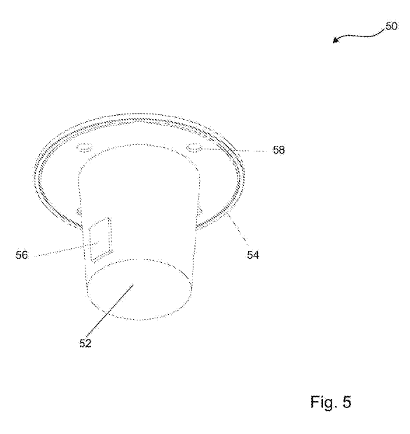

An embodiment 50 of the system for use with a table top is shown in FIG. 5. In this embodiment, the device uses a main body 52 which includes an actuator button 56 on the side of the main body. The main body 52 is mounted to a table or other surface (not shown) by attaching the main body 52 to the surface using conventional means, such as screws or other fasteners passing through the main body holes 58. The top of the main body 52 is covered by a charging pad 54, the lip of which is visible in FIG. 5. While the embodiment shown in FIG. 5 uses a main body 52 having a cup-like shape, other shapes for the main body 52 are used in other embodiments (not shown). For example, in one embodiment, the shape is substantially flat and puck like. The shape chosen in FIG. 5 ensures that the main body 52 does not extend beyond the boundaries of the lip of the charging pad 54. In this way, the main body 52 can be dropped into an aperture drilled into the tabletop requiring access to only one side of the tabletop.

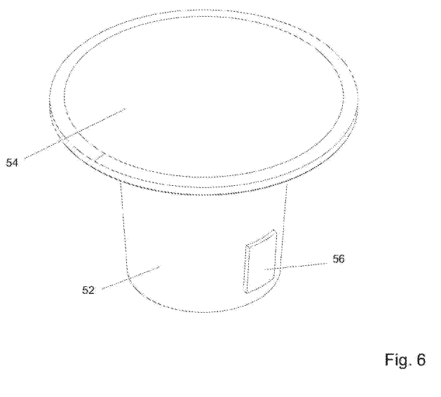

FIG. 6 depicts another view of the main body 52, the actuator button 56 and the charging pad 54.

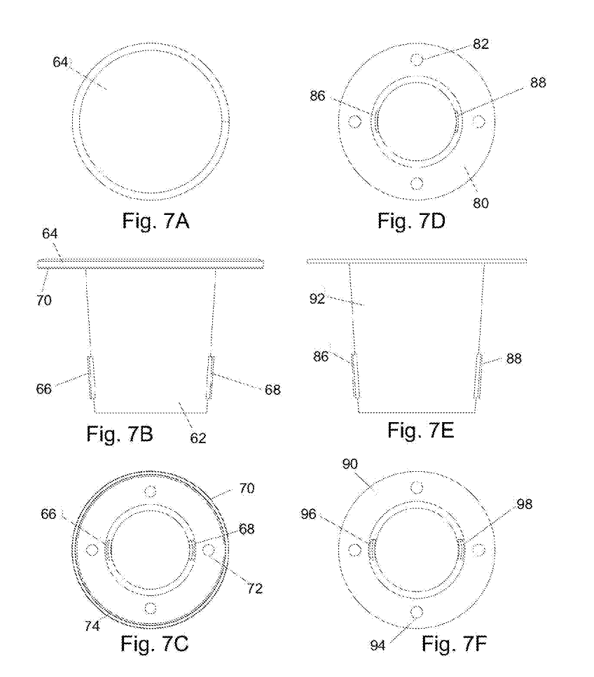

FIGS. 7A-7F depict several view of two embodiments of the tabletop embodiment. In this embodiment, the charger pad 64 is visible in the top view 7A. Side view 7B depicts the main body 62 which includes two actuator buttons 66 and 68. The main body 62 includes a second button 68 which must be pressed in conjunction with the first button 66 so as to prevent the unintended release of the charging pad 64. As the main body 62 is located underneath a table top, it is possible that the user of the table could bump into it and press the button inadvertently. Adding a second button 68 which must be pressed simultaneously with the first, prevents accidental release of the pad. In one embodiment, the buttons 66, 68 must be pressed simultaneously. In another embodiment, in order to release the charger pad 64, the end user must press the first button 66 and the second button 68 within a short time period thereafter, such as 2-3 seconds.

The main body 62 includes a mounting plate 70. The charging pad 64 is positioned such that it abuts the mounting plate 70. The details of the mounting plate 70 are shown in the bottom view shown in FIG. 7C. The mounting plate 70 includes four apertures 72. As shown in FIG. 7C, the mounting plate also includes a gasket or seal 74.

FIG. 7D depicts a bottom view of an embodiment which also uses two buttons 86, 88, but wherein the mounting plate 80 excludes a gasket or seal shown in FIG. 7C. The mounting plate 80 still includes four apertures 82. A side view of this embodiment is shown in FIG. 7E. The embodiment comprises a main body 92 and the two push buttons 86, 88. FIG. 7F depicts an embodiment of the invention wherein buttons 96, 98 have multiple levels. In this embodiment, the mounting plate 90 still also includes apertures 94.

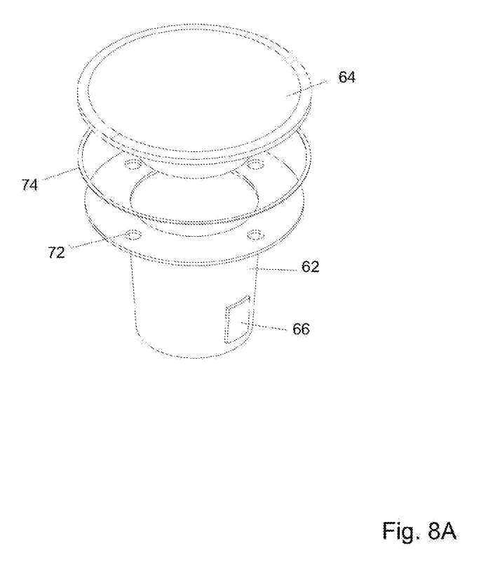

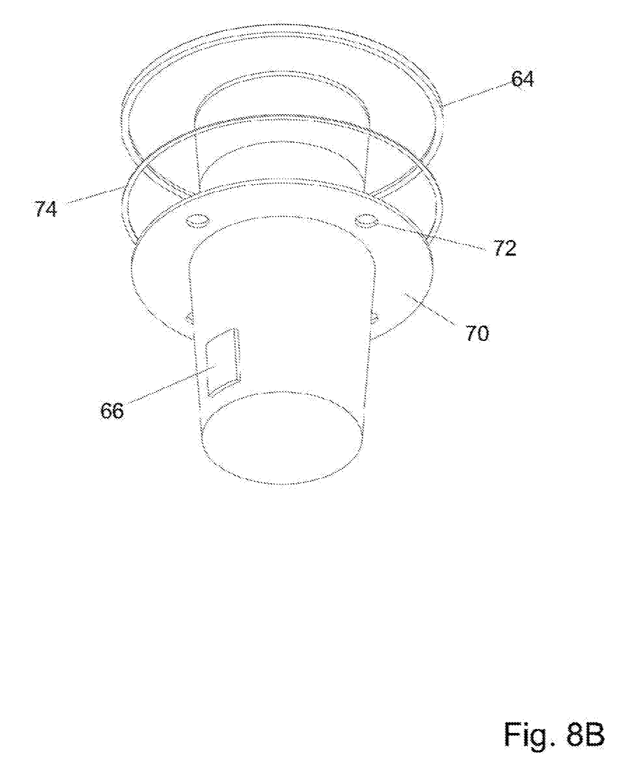

An expanded view of the gasket embodiment is shown in FIG. 8A. Visible in this figure is the main body 62 along with the charging pad 64, the gasket or seal 74 and the apertures 72. Along the side of the main body 62 at least one push button 66 is defined. FIG. 8B provides another view of this embodiment, showing also the mounting plate 70.

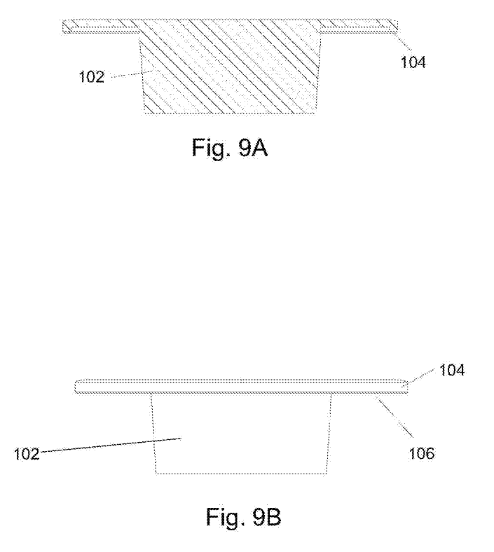

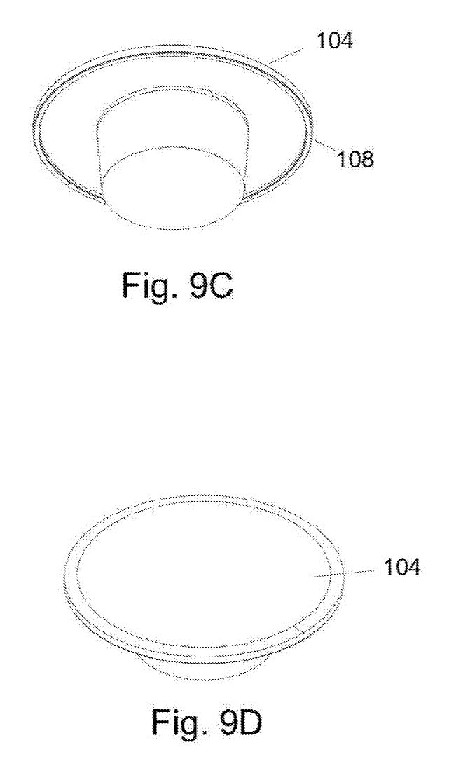

FIG. 9A depicts another embodiment wherein the main body 102 is shorter than the main body 62 depicted in earlier figures. As shown in the cut away view of FIG. 9A, the main body 102 is covered with a charging pad 104 which forms a lip over the top of the main body. Per FIG. 9B, the main body 102 includes a mounting plate 106 which is substantially covered by the charging pad 104. Per FIG. 9C, a seal or gasket 108 placed under the charging pad 104 is used in some embodiments of the invention. However, as shown in FIG. 9D, the gasket is not visible in a top view of the charge pad 104.

### Secure Embodiment

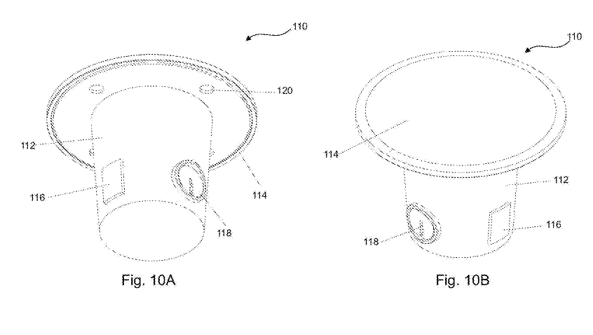

FIGS. 10A to 12E depict a secure lockable embodiment 110. Turning to FIGS. 10A and 10B, depicted therein is a secure embodiment 110 of the device. FIG. 10A shows the underside of the secure embodiment 110. The embodiment comprises a main body 112 which includes a mounting plate having several apertures 120, an actuator button 116, and a lock 118. A charging pad 114 is installed on top of the mounting plate.

The actuator button 116 will release the charging pad 114, however, only if the lock 118 is in the unlocked configuration. If the lock 118 is in the locked configuration, the actuator button 116 will be disabled and the end user will not be able to press the button, in one embodiment. In another embodiment, even when the lock 118 is in a locked configuration, the push button 116 will be operable, in that the end user will be able to push it, but the push button 116 will not release the charging pad 114.

A top view of the embodiment 110 is shown in FIG. 10B.

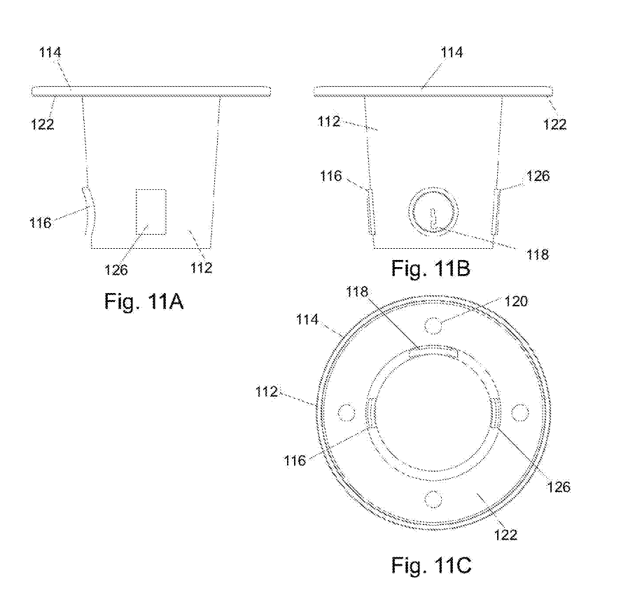

Further embodiments are shown in FIGS. 11A-C. The embodiment shown in FIG. 11A includes multiple push buttons 116, 126. The main body 112 of this embodiment includes a mounting plate 122 to which the charging pad 114 is attached. FIG. 11B shows an embodiment of the invention wherein the main body 112 includes a lock 118 and two actuator buttons 116, 126. This embodiment also includes the mounting plate 122 and the charging pad 114.

FIG. 11C shows a bottom view of the embodiment depicted in FIG. 11B. In this view the two buttons 116, 126 are visible along with the mounting plate 122 on the main body 112. The mounting plate 122 includes apertures 120. The charge pad 114 extends over the mounting plate 122.

While the embodiments shown in the figures above depict the buttons as on the sides of the main body of the device, in other embodiments, the push buttons may be found on other surfaces of the device.

In all of these embodiments, the charging pad includes a wired connection to a power source, such as a pair of conductors on one of the flanges. In one embodiment, the underside of the charge pad includes spring loaded conductors which engage with a corresponding receptacle on the main body of the device.

### Additional Fields of Use

While the depicted embodiments are designed to be used in conjunction with users of consumer electronics, the replaceable charge pad may also be used in other fields where charging standards change rapidly. A further embodiment, not shown allows for changing of wireless charging systems for electric car charging. Such a system can be deployed in a garage floor, on roads or streets, and other locations, such as parking lots. An additional embodiment is used for other charging applications, such as replaceable wall plate systems that allow for snap-in and snap-out of components.

Furthermore, an embodiment of the system includes contact-based electrical conductors as well. One embodiment allows for replacement of charging modules for electric vehicles. In this embodiment, instead of swapping out the wireless charge pad (such as pad 14 in FIG. 1A), the embodiment swaps connectors or plugs which are used for different styles of connectors.

### CONCLUSION

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

The present methods can involve any or all of the steps or conditions discussed above in various combinations, as desired. Accordingly, it will be readily apparent to the skilled artisan that in some of the disclosed methods certain steps can be deleted or additional steps performed without affecting the viability of the methods.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all sub ratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A wireless charger device comprising:
a main body;
a wireless charger inductive transmission plate;
at least one attachment mechanism mounted to the transmission plate;
at least one receiving mechanism permanently connected to a surface;
wherein said attachment mechanism is removably received by the receiving mechanism resulting in mounting of the transmission plate on the surface and wherein said attachment mechanism allows for removal of said receiving mechanism.

2. The device of claim 1 wherein said receiving mechanism comprises an oval frame further comprising a first actuator button.

3. The device of claim 1 wherein said receiving mechanism comprises a snap fit with extending arms wherein said extending arms are extended or retracted based on actuation of a mechanism.

4. The device of claim 3 wherein said mechanism comprises an actuator button.

5. The device of claim 1 wherein said attachment mechanism and said receiving mechanism further comprises conductors to transmit electricity to the transmission plate.

6. The device of claim 1 wherein said receiving mechanism results in secure attachment of said transmission plate.

7. The device of claim 1 further comprising an outlet or charging cable.

8. The device of claim 6 whereby the device is in a secure lockable embodiment configuration.

9. The device of claim 1 further comprising a gasket or seal.

10. The device of claim 9 wherein the gasket or seal is not visible.

11. The device of claim 2 further comprising a second actuator button.

12. The device of claim 1 wherein the main body has a cup-like shape.

13. The device of claim 1 wherein the main body is substantially flat.

14. The device of claim 1 wherein the main body does not extend beyond the main boundaries of the charging pad.

15. The device of claim 14 wherein the main body can be dropped into an aperture drilled into a tabletop.

16. The device of claim 1 further comprising a mounting plate.

17. The device of claim 16 wherein the mounting plate comprises four apertures.

18. A method of installing a charger pad of the wireless charger device of claim 1, the method steps comprising:
Connecting the device to a power source;
Installing a charging pad on top of a mounting plate;
Pressing an actuator button;
Retracting a locking flange;
Raising a bottom push flange;
Pushing a charger out of a frame; and
Presenting a charger pad to a user.

19. The method steps of claim 16 further comprising removing the charger pad out of the frame.

20. The method steps of claim 19 further comprising engaging a lock.
